(19) United States
(12) Patent Application Publication
(10) Pub. No.: US 2021/0212525 A1
(43) Pub. Date: Jul. 15, 2021

(54) Cleaner Smaller Bathrooms

(71) Applicant: Sasi Kumar Lekkala, IRVING, TX (US)

(72) Inventor: Sasi Kumar Lekkala, IRVING, TX (US)

(21) Appl. No.: 16/525,558

(22) Filed: Jul. 29, 2019

(51) Int. Cl. A47K 11/12; A61G 9/00

(52) U.S. Cl. CPC A47K 11/12; A61G 9/006

(57) ABSTRACT

A retractable, height-adjustable urinal requiring no water that can be enclosed into a separate closed compartment for cleaning/disinfecting along with a waterless toilet that packages and disposes of solid waste, in a smaller place.

### BACKGROUND

We all have gotten the uncontrollable urge to use a public bathroom knowing that the experience will be unbearable. From the puddles under mens urinals to ugly concert mobile potties, we have probably seen it all. We will try to analyze each component of a bathroom and see if we can tidy up a few things. The existing

### SUMMARY

We will take different components and types of bathrooms and see how they can be assembled for a cleaner area, that is compact and will cost significantly less than the existing infrastructure.

### Mens' Urinals:

The Mens' urinal area becomes dirty with a few uses and within a few minutes of a cleaning process. The overarching reason for this problem is that the only available height of the urinal pot (Urinal bin and/or commode are referred to as a urinal bin or bins or pot in this document) to a man's crotch level. It is usually at a perfect height for some, but too high or too low for the majority. As urinals must be built to accommodate everyone including small children, and for that reason, urinals are sometimes built low to the ground. Frequently, there is only one bin built at a minimal height that accommodates small children (an outlier group), due to space and economic constraints, which is too low for most men to use them.

A container that hosts this pot and moves it up or down is the answer. Adjustable height for the urinal pot will help clean most of the issues. This height adjusting mechanism of the bin can be automatic or hand-adjustable. The height of the bin associated with a number or a markers that one can remember will make it consistent. A standard marker or number on all installations can help a person to select their choice easily.

The second reason for the messiness at mens urinals is the fear of stepping in urine. There is usually a puddle under the bin in most occasions. The unwillingness to step into another man's pee makes a person stand a little further away from the bin to avoid stepping in the puddle. That in turn makes it worse. This puddle starts with just a drop or two. These drops end up forming a puddle in minutes after a few uses.

The answer to this problem is that we need to provide a cleaner pot to pee in and a cleaner floor to stand on. The pot can be made retractable to return back into a(n) container/enclosure after use to save space and/or clean better. Also, this gives the bin a chance to be cleaned for every use. The pot can be exposed to a strong disinfectant in the containment rather than it being exposed. As it will contain a stronger disinfectant spray that can be used and/or the pot can also be exposed to other forms of disinfectants and deodorants. Some possible methods include disinfecting light, heat, pressure, suction, steam and/or some other mechanism. The enclosure can also dispose of any fluid within the bin from its last use. This leaves little trace of urine or smell for the next use.

The other reason for the urine puddle under the pot is really not urine. The puddle usually starts with a drop or two. Those few drops could even be water. The flush splashing, the pipe leaking, and/or the bin overflowing are all a common scene at these pots. To fix the leaks and to save all that water we use to flush, we need to rethink if we really need water. No water will separate urine from all other gunk as well. With modern technologies of no water urinals and the added advantage of an enclosure that can be used for cleaning, water use will not be necessary. Some concerns are going to be smell, how the bin looks after a usage and other hygiene. With the enclosure we can retract the bin and clean it. Each usage may take a few seconds to clean. Enough time for a guy to zip up and step aside for the next. Putting more bins in the enclosure is also an option. Exposing a bin while the other goes through a cleaning cycle is a possibility. Clusters of these vertical enclosures next to each other could be practical for some scenarios.

The device would be extremely useful for disabled people in wheelchairs or bed-ridden or if a person has some difficulties with mobility. If it is built correctly a woman use it as well. An enclosure could provide an option to pick male or female, narrow or wide, and/or detachable.

There is no question that men prefer to pee standing. However, there is no such provision in any common home's powder room. The men peeing loudly into that low commode is a common scene—some of it gets splattered all around. This leaves a ugly scene for the next person that walks in and usually the smell gets worse the next day. I am sure there is no woman who hasn't been disgusted by a man's use of their home toilet either the smell at times or the guys leaving the seat upright. The adjustable height, compact bin, and disposal of fluids using no water could be an option for every powder room and a bathroom. If we can connect it to a power source the options of cleaning and adjusting height can be automated.

DC motors can accomplish these same tasks for outdoor installations. Solar panels can provide the needed power. My preliminary proof of technology shows me one solar panel with a car battery charged fully could do the job for thousands of uses.

This device and/or utility will also allow for collecting the pure urine for any power generation or producing fertilizers.

If the pot is at a correct height for a person, it need not be huge. A compact enclosure design can be provided. It will be suitable in any compact area or even on transportation vehicles or other compact areas. It will become an option to install them in high traffic areas as well, with privacy enclosure. This will reduce costs of regular mobile potties. This device will be a novelty for most scenarios and useful for mankind in general with saved water and porcelain and other infrastructure materials being used currently.

As the urinals become height adjustable, the peripherals around them or going to require height adjustment such as: the soap dispenser, trash disposal, sink and/or hand dryer. All these can be made height adjustable or the vertical enclosure of the bin can also be made a 3 or 4 sided column to host all other equipment that can be moved to a desired height along with the bin. Also, If we leave the height at a default of a small kid, he can reach all the needed implements without a stool that you see in some restrooms. Some of these height adjustable facilities can also be incorporated for little girls and shorter women too.

### Mobile Potty Units:

These units are notoriously untidy, but how we can improve them is the question. The answer is a collection unit that wraps the excretions and discharges them into a bin. If we can do this process that will not smell will be a great alternative to what we have. Technology is there to pack the unwanteds even at a small scale with a small budget and with minimal power.

Modern technologies can power this unit as well as control access to unit and/or: monitor, notify, alert, tamper proof, and abuse-proof the unit.

Imagine using a pot that is covered with some material that can become a cover for the excretions. It can be repacked well in a durable material and/or packed multiple times if needed. The irony of how we wash hands is still going to be a question. We need to provide wet towels. The bin also can be used to discharge toilet paper and wet towels in the same bin before packing. If they can use a wet towel as toilet paper. That would even be preferable and we all can clean ourselves a little better—however thoroughly you clean yourself with a dry paper, you will never be quite clean

There are existing processes to make poop into dirt. The solid waste packets can be turned into fertilizer in couple of months, If we can package the solid waste with the right ingredients. Just by adding sugarcane bagasse is enough to kill all pathogens and turn it to dirt. The packages will be ready to be disposed off safely or be used as fertilizer. Or imagine a foam or glue built with these ingredients prefilled in the pot, measured to fit a purpose and can avoid all odor or improve hygiene.

Now let us ask why this unit can not be our solution for not just any mobile potty but to replace any commode. Commodes are bulky beasts that hold significant amounts of water. Do we really need these our new device. The amount of water we waste is the least of our problems with these. Issues with these range from male organs touching water to breaking, flooding, splashing, leaking, clogging and the unending associated cost of maintenance and the sleepless nights with sounds of flapper leaking, floater dropping, water filling, floater resetting as a cycle, all night long.

Imagine a compact contraption that can do the same job but better. This could be very helpful to somebody in a wheelchair or that is bed-ridden.

1. Adjustable urinals to suit a person's crotch height, weight, or other preference

2. Urinals in claim 1, in every home's powder room, bathroom, mobile unit, wheel chair, indoor, outdoor, portable units, any compact area, any area with small privacy enclosure and/or enclosed into a structure or exposed openly

3. Urinals in claim 1, that uses water or no water. No water option associated with alternative cleaning mechanisms that use any disinfecting mechanism and any deodorizing mechanisms. These cleaning mechanisms can be for each use or as a continuous cleaning process that uses some form of power to adjust height and do the cleaning process

4. Urinals in claim 1, that can be adjusted up or down for height and/or monitored, alerted with status or other notifications and/or operated only with a proper authentication of a person and/or accessed by a smart device

5. Urinals in claim 1, with a local collection system, if no plumbing exists or to use the collection for any other purpose.

6. Urinals in claim 1, to have known, memorable or adjustable setting for a person's height or other preference

7. Urinals in claim 1, to be installed as a cluster to save space and/or other resources and provide multiple private areas for multiple people to use at the same time.

8. Urinals in claim 1 with all other associated claims to be implemented for other reachable moving mechanisms as dryers, soap dispenser and/or other bathroom peripherals or commodes

9. Waterless commode that packs excretions and any other waste to dispose off

10. The packs in claim 9, to be packed multiple times for added safety and hygiene

11. Commode in claim 9 along with its associated claims and urinals in claim 1 along with its associated claims, to be built as one unit to serve the purpose of a cleaner and compact bathroom.

12. Commode in claim 9 along with its associated claims and urinals in claim 1 along with its associated claims to be installed in a wheelchair, bed, or any other mobile or stationary unit or for a pet or animal

13. Height adjustable bathroom utilities to suite different height or preference

14. Commode in claim 9, to have a liner to the bin that can be used for packing the solid waste

15. Commode in claim 9, to have a separator to collect urine and solid waste separately

16. The packs in claim 9, to be packed with other ingredients to turn solid waste into dirt/fertilizer. Adding needed safe bacteria, sugarcane bagasse or other deodorants or other dirt/fertilizer making agents based on a sensor reading

17. Height adjustable household utilities

18. Commode in claim 9 along with its associated claims and urinals in claim 1 along with its associated claims to be installed with automated cleaning of body parts

19. Urinals in claim 1, multiple of them to be enclosed with different sizes, shapes and other needs to be switched and provide the right one to the user preference

20. Mechanism described in claim 16 to be prefilled into the pot to reduce odor, increase hygiene and/or other aesthetic purpose.
